(19) United States
(12) Patent Application Publication
(10) Pub. No.: US 2010/0070587 A1
(43) Pub. Date: Mar. 18, 2010

(54) EMBEDDING RESURFACING TRIGGERS IN CLIENT SIDE RECIPIENT ELECTRONIC MAIL

(75) Inventors: Itzhack Goldberg, Hadera (IL); Avner Levi, Karmiel (IL); Uri Silbershtein, Mazkert Batya (IL); Mary Ellen Zurko, Groton, MA (US)

Correspondence Address: Cantor Colburn LLP-IBM Europe, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/210,563

(22) Filed: Sep. 15, 2008

(51) Int. Cl. G06F 15/82

(52) U.S. Cl. 709/206

(57) ABSTRACT

A method for utilizing embedded resurfacing logic in electronic mail (email), the method includes: receiving an email with embedded resurfacing logic at a recipient's email client; determining whether the recipient has opened the email; wherein in the event the email has not been opened: determining whether a triggering event has occurred; wherein in the event a triggering event has occurred and has not exceeded a maximum number of triggering events: generating a resurfaced email entry at the top of the recipients email inbox, and wherein the triggering event is a predefined time interval in which the recipient has not opened the email.

### BACKGROUND

This invention relates generally to computer software, and more particularly to a method and system for embedding a resurfacing logic in electronic mail.

Electronic mail (email) has become a central feature of modern life and users have come to expect to receive electronic mail messages at any time and in virtually any place. For example, during the course of one day of travel, a user may receive electronic mail messages at a home desktop computer in the early morning, an office desktop computer in midmorning, via a cell phone or personal digital assistant in a taxi on the way to the airport, on a laptop computer via a wireless local area network while waiting in the airport lounge, via an in-flight telephone on the airplane, and in a hotel room via a high-speed Internet connection provided by the hotel at the end of the day.

The widespread proliferation and availability of electronic messaging has provided an efficient method to communicate information. In fact electronic messaging with its near instantaneous delivery from sender to receiver has become the preferred method of personal and business communication where hardcopy signatures are not required. In addition the ease of use and minimal cost of distribution has led to mass email to large distribution lists, as well as using email as a broad collaborative tool.

### SUMMARY

Embodiments of the present invention provide a method for utilizing embedded resurfacing logic in electronic mail (email), the method includes: receiving an email with embedded resurfacing logic at a recipient's email client; determining whether the recipient has opened the email; wherein in the event the email has not been opened: determining whether a triggering event has occurred; wherein in the event a triggering event has occurred and has not exceeded a maximum number of triggering events: generating a resurfaced email entry at the top of the recipients email inbox, and wherein the triggering event is a predefined time interval in which the recipient has not opened the email.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a flow chart for a method of embedding a resurfacing logic in electronic mail according to embodiments of the invention.

FIG. 2 illustrates a system for implementing embodiments of the invention.

The detailed description explains the preferred embodiments of the invention, together with advantages and features, by way of example with reference to the drawings.

### DETAILED DESCRIPTION

The explosive growth in the use of email has led to the use of email as a collaborative, and information tool. However, the explosive growth in email usage has also led to an “email-overload” for both email users and email systems.

Email may generally be sorted or divided by electronic communications that require an action or reply response by a recipient, and emails that do not require a response. Typically, emails where the recipient is identified in the carbon copy (CC) or blind carbon copy (BCC) lines of the email address field do not require a recipient's acknowledgement or response to the sender of the email. However, in the event the recipient is identified in the ‘TO’ line, the sender of the email may be expecting an acknowledgement or response from the recipient.

Despite the prevalence of email usage, cultural differences, as well as a lack of an agreed to standard for email usage, often leads to email getting ‘lost’ among less important emails. Important emails, as deemed by a sender, may be tracked and resent until a recipient response is received, thereby further contributing to the aforementioned “email-overload.”

Embodiments of the invention provide a method and system for embedding a resurfacing logic in electronic mail. In embodiments of the invention, a recipient's email client monitors and responds to the embedded resurfacing logic to resend or reposition a received email in the recipient's email inbox. With the embedded resurfacing or trigger logic, of embodiments of the invention, the email sender may instruct the recipient's email client to resend or resurface the sender's email to the top of the recipient's inbox at a predefined time interval (triggering event) for a defined number of occasions in the event the recipient has not opened the email. In embodiments of the invention, an email that is read or deleted by the recipient is considered a response to the email sender, and the embedded resurfacing logic is disabled. In embodiments of the invention, the resurfaced email may be presented in the recipient's inbox with a color code or flag to indicate that the email has been resurfaced.

In embodiments of the invention, a recipient may be notified of a resurfaced email through a voice notification, such as via voice over Internet protocol (VoIP). In a voice notification a recipient may be provided with the name of the sender and email subject. Additionally, the email message body may be provided to the recipient via the voice notification. Further embodiments of the invention may provide notifications to a recipient via text messaging via instant message (IM) and short messaging system (SMS)

In embodiments of the invention, resurfacing logic may be embedded in the email at a later time, after an originating sender sends the email to a recipient. The flexibility of embedding resurfacing logic into previously sent emails provides for additional recipient notifications, such as when an email is meant to be forwarded to complete a message's travel to a chain of association to be communicated out.

In embodiments of the invention, a recipient may be notified after a certain period of time passes; only in the event the recipient has communicated previously with a sender within some other defined time period. For example, notification maybe provided to a recipient in the event the recipient has communicated with a sender within the past week. In addition, a recipient may be notified of an older email that has not been responded to, when the recipient attempts to respond to a more recent email from the same originating sender.

Embodiments of the invention may be integrated with online social networks, so as to provide notification only in the event a sender is in a recipient's direct social network, or within a predefined number of relationship levels (hops) away from the recipient's social network. Further embodiments of the invention, may rely on integration within organization charts, which provides for notifications based on groupings and organizational relationships and rankings.

Within an integrated collaborative system, embodiments of the invention may provide a notification via an IM within a Web conference, with a calendar entry such as a new “to do” or task item in an activity, through a VoIP or SMS message, with a response in a blog or other discussion type forum such as a community, wiki, twitter, and adding personal tags to a message in a tagging system (dogear).

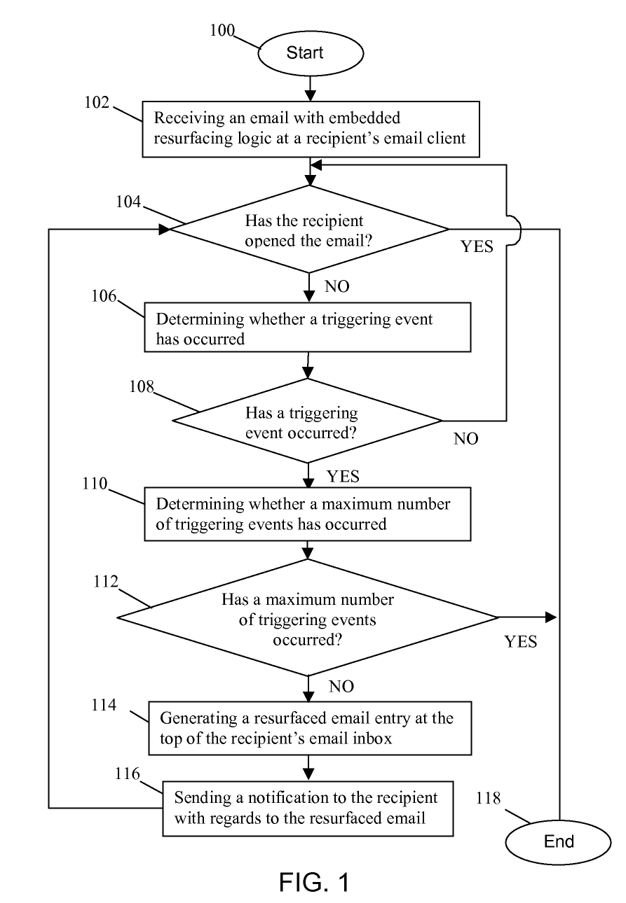

FIG. 1 illustrates a flow chart for utilizing embedded resurfacing logic in electronic mail according to embodiments of the invention. The process starts (block 100) with the receiving of an email with embedded resurfacing logic at a recipient's email client (block 102). In the event the recipient opens the received email (decision block 104 is Yes) the process concludes (block 118). However, in the event the recipient has not opened the email (decision block 104 is NO), a determination is made of whether a triggering event has occurred (block 106), such as a predefined period of time elapsing. In the event a triggering event has not occurred (decision block 108 is NO), the email client continues to monitor for an opening of the email with the embedded resurfacing logic (returns to block 104). In the event a triggering event has occurred (decision block 108 is Yes), a determination is made of whether a maximum number of triggering events have occurred (block 110). In the event the maximum number of triggering events has occurred without the recipient opening the email with the embedded resurfacing logic (decision block 112 is Yes), the process concludes (block 118). However, in the event the maximum number of triggering events has not occurred without the recipient opening the email with the embedded resurfacing logic (decision block 112 is No), a resurfaced email entry is generated at the top of the recipient's email inbox (block 114), and a notification may optionally be sent to the recipient regarding the resurfaced email (bock 116).

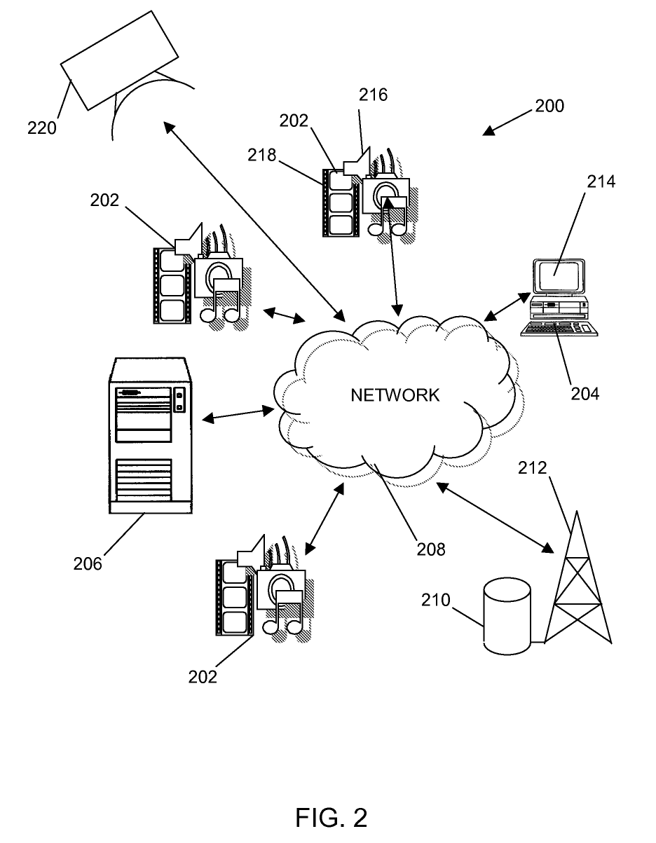

FIG. 2 is a block diagram of an exemplary system 200 configured for utilizing embedded resurfacing logic in electronic mail. The system 200 includes multimedia devices 202, and desktop computer devices 204 configured with display capabilities 214. The multimedia devices 202 may be mobile communication and entertainment devices, such as cellular phones and mobile computing devices that are wirelessly connected to a network 208. The multimedia devices 202 have video displays 218 and audio outputs 216. The multimedia devices 202 and desktop computer devices 204 may be configured with software with a GUI for carrying out the email resurfacing and notification functions of embodiments of the invention. The network 208 may be any type of known network including a fixed wire line network, cable and fiber optics, over the air broadcasts, satellite 220, local area network (LAN), wide area network (WAN), global network (e.g., Internet), intranet, etc. with data/Internet capabilities as represented by server 206. Communication aspects of the network are represented by cellular base station 210 and antenna 212. In a preferred embodiment, the network 208 is a LAN and each remote device 202 and desktop device 304 executes a user interface application (e.g., web browser) to contact the server system 206 through the network 208. Alternatively, the remote devices 202 and 204 may be implemented using a device programmed primarily for accessing network 208 such as a remote client.

The email resurfacing and notification software, of embodiments of the invention, may be resident on the individual multimedia devices 202 and desktop computers 204, or stored within the server 206 or cellular base station 210.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

1. A method for utilizing embedded resurfacing logic in electronic mail (email), wherein the method comprises:
receiving an email with embedded resurfacing logic at a recipient's email client;
determining whether the recipient has opened the email;
wherein in the event the email has not been opened:
determining whether a triggering event has occurred;
wherein in the event a triggering event has occurred and has not exceeded a maximum number of triggering events:
generating a resurfaced email entry at the top of the recipients email inbox, and
wherein the triggering event is a predefined time interval in which the recipient has not opened the email.

2. The method of claim 1, wherein the method further comprises color-coding or flagging the resurfaced email entry.

3. The method of claim 1, wherein the method further comprises notifying the recipient of the resurfaced email.

4. The method of claim 3, wherein the notifying is provided via voice notification.

5. The method of claim 3, wherein the notifying is provided via text messaging.

6. The method of claim 3, wherein the notifying occurs in the event an older email with embedded resurfacing logic from an originating sender has not been responded to, when the recipient attempts to respond to a more recent email from the same originating sender.

7. The method of claim 1, wherein the resurfacing logic is embedded in a recipient's email following receipt of the email at the recipient's email client.
